(19) United States
(12) Patent Application Publication
(10) Pub. No.: US 2004/0010923 A1
(43) Pub. Date: Jan. 22, 2004

(54) Cutting guide

(76) Inventors: Matthew Guiver, Charlton Kings (GB); Katarina Henrics Dotter Sanderup, Goteborg (SE)

Correspondence Address: SWIDLER BERLIN SHEREFF FRIEDMAN, LLP, 3000 K STREET, NW, BOX IP, WASHINGTON, DC, 20007, US

(21) Appl. No.: 10/197,547

(22) Filed: Jul. 18, 2002

(51) Int. Cl. B26B 13/22; B26B 29/06

(52) U.S. Cl. 30/233; 30/286; 30/296.1

(57) ABSTRACT

A cutting guide for a cutting device such as a pair of scissors. A body portion is adapted to be fixed adjacent to a blade portion of the cutting device. The body portion further includes a movably mounted measuring guide. The measuring guide has markings indicative of distance from the blade such that upon alignment of an edge of the guide to a point of reference, such as a dressmaker's pattern, a required seam allowance can be cut by the cutting device.

This invention relates to a cutting guide for cutting devices, such as scissors.

Dressmaking, tailoring, and other fabric cutting operations commonly use a pattern that the dressmaker, seamstress, tailor or other such person places on the cloth or material to be cut as a template, that is then marked or chalked around. The chalking out around the pattern pieces is often a long and laborious process, but is essential in order for an accurate seam line to be cut. The seam allowance, which is commonly 1 cm to 1.5 cm but can vary from 0.5 cm to 5 cm, is marked or chalked onto the cloth or material all around the pattern, usually in the form of a dotted line. The cloth or material is then cut along the chalk lines.

The present invention is derived from the realisation that there is a need for a device that enables the dressmaker, seamstress or tailor to cut the pattern accurately along the line of the seam allowance chosen, without the need for the time-consuming marking out process. The present invention therefore aims to obviate the marking out process and reduce two processes related to cutting cloth to a pattern, into one.

According to a first aspect of the invention there is provided a cutting guide for a cutting device, such as a pair of scissors, the guide comprising a body portion adapted to be fixed adjacent to a blade portion of the cutting device, the body portion further including a movably mounted measuring guide, the measuring guide having markings indicative of distance from the blade such that upon alignment of an edge of the guide to a point of reference, such as a dressmaker's pattern, a required seam allowance can be cut by the cutting device.

Preferably, the body portion is adapted to be fixed to a metallic blade portion of the cutting device by means of a magnet and the measuring guide is slidably mounted within a sleeve on the body portion, preferably for movement normal to, but generally in the plane of, the line of cut.

The measuring guide may conveniently include one or more openings through which a point of reference such as a cutting line of a cloth may be viewed, the one or more opening being conveniently generally elliptical.

According to another aspect of the invention there is provided a cutting device incorporating an integral cutting guide, the cutting guide having a body portion, the body portion further including a movably mounted measuring guide, the measuring guide having markings indicative of distance to the blade, such that upon alignment of the edge of the guide to a point of reference, such as a dressmaker's pattern, a required seam allowance can be cut by the cutting device.

The measuring guide may preferably be in the form of a ruler which takes its datum point from the blades of the cutting device and its measuring axis from the line of cut. This provides a point from which an accurately measured allowance or distance can be selected, left or right of the axis, which in turn provides an accurate seam allowance. The measuring guide is then moved parallel to the edge of the prepared/ pinned pattern to provide the required allowance.

The invention provides that the seam allowance can be adjusted with reference to the markings on the measuring guide, which may be marked with both imperial and metric units, it being preferable that the cutting guide also include a point of reference for the measuring guide so that any seam allowance can be chosen and positioned by the dressmaker, seamstress or tailor.

A preferred method of releasably securing the measuring guide with respect to the cutting guide is by the use of magnetic strips which therefore hold the measuring guide in a desired position through magnetic attraction such that if at any point during the cutting operation the seam allowance needs to be changed, sufficient finger pressure to overcome the magnetic attraction between the measuring guide and the magnetic strips is simply applied left or right of the cutting device and, once reset to the desired width, the cutting operation can recommence.

It will be understood that the invention may be utilised for purposes other than simply dressmaking and may even find applicability in assisting in cutting, e.g. measured pieces of silver or, if fitted to garden shears, in cutting hedges to measured lengths.

The invention will now be described, by way of example only, with reference to the accompanying drawings in which:

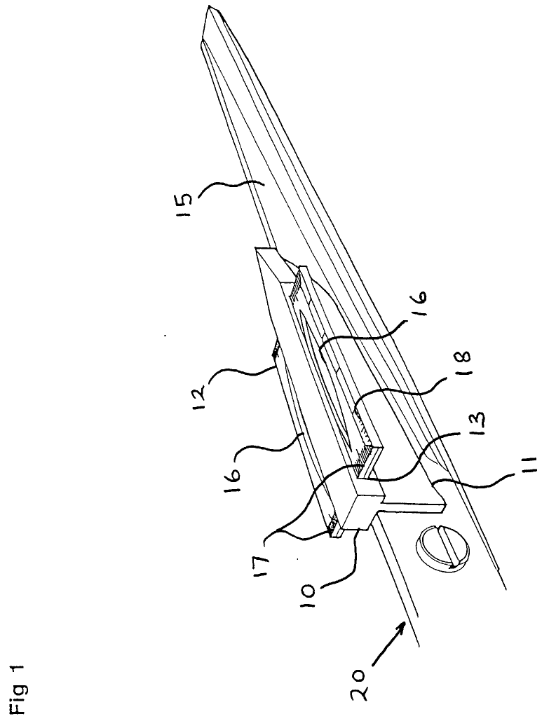

FIG. 1 shown in perspective a cutting guide positioned onto a cutting device in the form of a pair of scissors; and

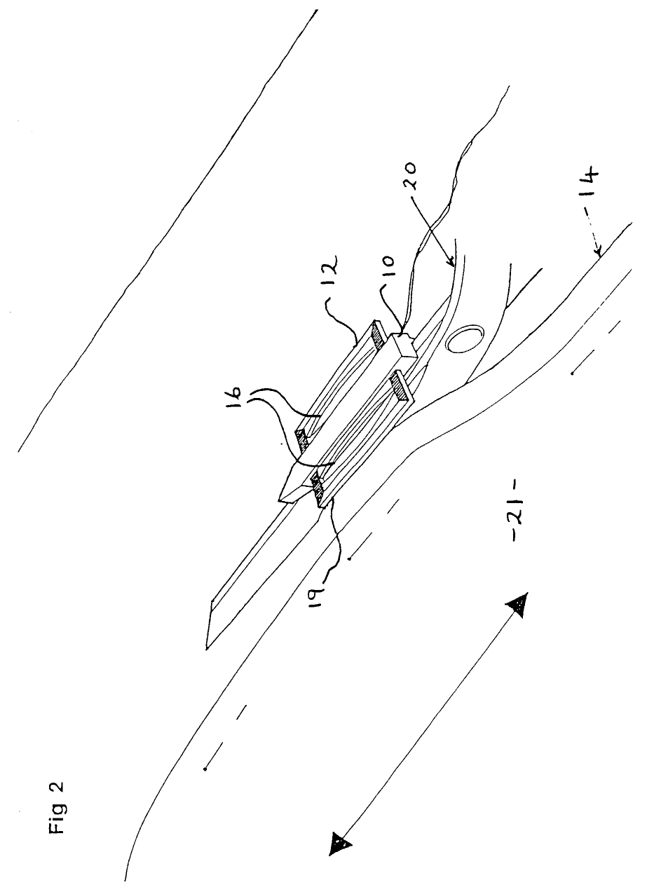

FIG. 2 is a perspective view of the cutting guide and cutting device of FIG. 1 shown in operation.

Referring to the drawings, the cutting guide comprises a body portion 10 which is shown temporarily attached to an edge face of a blade 15 forming part of a conventional pair of scissors shown generally at 20. The attachment is facilitated by a flanged region 11 of the cutting guide incorporating one or more magnets (not shown) so that after it is placed in position at a suitable part of the blade 15 it is releasably held there firmly in place by magnetic attraction. The cutting guide 10 includes a measuring guide 12 which is slidably received within a correspondingly shaped slot 13 within the body portion 10 so that, in the examples shown, the measuring guide 12 is slidable left or right of the line of cut 14 shown in FIG. 2.

The measuring guide incorporates a pair of generally elliptical openings 16 through which a point of reference such as the line of cut of a cloth may be viewed on either side thereof. The measuring guide includes markings 17 indicative of distance from the line of cut 14 (which markings may be on both faces of the measuring guide 12, one metric and the other imperial units, for example) and conventional ruler markings 18 which can be used for measuring small distances as an optional feature.

As can be seen more clearly with reference to FIG. 2, the measuring guide 12 can be simply adjusted by hand to locate a desired seam width, using sufficient finger pressure to overcome friction or, if incorporated therewithin, magnetic strips such that the measuring guide is thereafter releasably held firmly in the chosen position.

In operation, the dressmaker, seamstress or tailor selects a seam width with reference to the pattern 21 and adjusts the measuring guide using the markings 17 accordingly. Once the pattern has been pinned or fastened as shown in FIG. 2, the user lines up the outer edge 19 of the guide 12 parallel to the edge of the pattern 21. The user then cuts using the cutting device, in this case a pair of scissors 20, and in order to assist in viewing the actual line of cut can use the openings 16 for that purpose. If at any time during the operation the seam width needs to change or the reverse side of the measuring guide 12 is needed to show different measuring units, e.g. metric or imperial, the whole assembly, i.e. the cutting guide and the cutting device, can simply be removed from its cutting position and adjusted accordingly, before recommencement of the cutting operation takes place. Thus, the present invention obviates the need to mark out a seam allowance prior to the cut.

Although the preferred method of attachment of the cutting guide is by magnetism, alternative methods may be used including interlocking hooks and loops in high modulus polymer fibre strip form or other known forms of interlocking devices shaped and attached to a face or edge or part of the scissors. High modulus hooks and loops or other known interlocking devices could also be utilised as an attachment for other types of cutting tools/devices which could therefore provide a cutting guide or some other measuring capability suitable to the cutting tool/device in hand.

Sprung hand pressure pads could be incorporated into the scissors or, again, other cutting tools/devices that enable the user to clip the cutting guide into position.

Fastening devices of known form such as bulldog clips, spring clips, drawing type pressure clips, over-centre clips or other known forms of clips may be incorporated into the body of the cutting device as the female part. In this case, the male part would be incorporated into the cutting guide and attached as desired to the female parts on the cutting tool/device. Further alternatives could use double-sided adhesive tapes or adhesives such as anaerobic, epoxy or other known adhesives which could again provide the means for either a cutting guide or some other measuring capability suitable to the cutting tool/device in hand, to measure an accurate seam allowance or other distance.

Preferably, the cutting guide is made by a low temperature thermoset or thermoplastic moulding technique, capable of incorporating metallic parts for strength or function. It may be manufactured by various means and of any material that can be suitably manufactured such as already described or from a metal, an alloy or a composite material. The material and methods used must, in the preferred form of the cutting guide, be suitable to incorporate either pre-magnetised components or be of a material that can be magnetised or that can incorporate components or particles of material that can be magnetised.

The measuring guide may incorporate a ratchet assembly, thus allowing it to move left or right laterally with a click, to provide a measured width or seam allowance. The cutting guide itself may be made up of two or more tapered strips or plates that pass or slide alongside or over one another to thereby vary the distance towards the datum point on the cutting guide.

Grub screws could be incorporated into the body of the cutting guide, thus allowing the user to choose the required seam allowance before holding fast the desired width.

Fastening devices, again in the known forms of various clips such as bulldog clips, spring clips, drawing board pressure clips, over-centre clips or other known clips could be incorporated on to the body of the cutting guide to provide the means to adjust the measuring guide and hence provide an accurate seam allowance.

Another alternative is to use a pivot point acting as the axis for the cutting guide to rotate about, increasing in width for the seam allowance as it does so.

Yet another alternative would be to use a rack and pinion method to allow free movement in opposing directions of the measuring guide, which in turn provides an accurately measured seam allowance/distance. A further alternative could be to manufacture protrusions onto rulers that would locate in a recess on a slot by means of a push fit, thus providing a measured seam allowance/distance.

Interlocking hooks and loops in high modulus polymer fibre strip form are adjustable by nature of its design and thus could be used to provide an adjustable measuring guide with the required seam allowance.

The measuring guide may incorporate alternative viewing arrangements, for instance transparent material with metallic inserts with magnetic properties, metallic guides with magnetic properties and various holes, slots or transparent inserts which give visual access to the point of cut.

1. A cutting guide for a cutting device, such as a pair of scissors, the guide comprising a body portion adapted to be fixed adjacent to a blade portion of the cutting device, the body portion further including a movably mounted measuring guide, the measuring guide having markings indicative of distance from the blade such that upon alignment of an edge of the guide to a point of reference, such as a dressmaker's pattern, a required seam allowance can be cut by the cutting device.

2. A cutting guide according to claim 1 wherein the body portion is adapted to be fixed to a metallic blade portion of the cutting device by means of a magnet.

3. A cutting guide according to claim 1 or claim 2 wherein the measuring guide is slidably mounted within a sleeve on the body portion.

4. A cutting guide according to claim 3 wherein the measuring guide is slidably mounted for movement normal to, but in the plane of, the line of cut.

5. A cutting guide according to claim 3 or claim 4 wherein the measuring guide includes an opening through which a point of reference such as a cutting line of a cloth may be viewed.

6. A cutting guide according to claim 5 wherein the opening is generally elliptical.

7. A cutting guide according to claim 5 or claim 6 wherein the measuring guide has a pair of openings for viewing opposing sides of the line of cut of the cutting device.

8. A cutting guide according to any preceding claim wherein the measuring guide has different distance measuring units on opposing faces thereof.

9. A cutting device incorporating an integral cutting guide, the cutting guide having a body portion, the body portion further including a movably mounted measuring guide, the measuring guide having markings indicative of distance to the blade such that upon alignment of the edge of the guide to a point of reference, such as a dressmaker's pattern, a required seam allowance can be cut by the cutting device.

10. A cutting guide for a cutting device substantially as hereinbefore described with reference to the drawings.
